(19) United States
(12) Patent Application Publication
(10) Pub. No.: US 2016/0032146 A1
(43) Pub. Date: Feb. 4, 2016

(54) ORGANIC/INORGANIC TRANSPARENT HYBRID FILMS AND A PROCESS FOR PRODUCING THE SAME

(71) Applicant: NATIONAL INSTITUTE OF ADVANCED INDUSTRIAL SCIENCE AND TECHNOLOGY, Tokyo (JP)

(72) Inventors: Atsushi HOZUMI, Nagoya-shi, Aichi (JP); Chihiro URATA, Nagoya-shi, Aichi (JP); John Benjamin MASHEDER, Nagoya-shi, Aichi (JP)

(21) Appl. No.: 14/772,662

(22) PCT Filed: Mar. 8, 2013
(86) PCT No.: PCT/JP2013/056537

§ 371 Date: Sep. 3, 2015

(51) Int. Cl. C09D 183/04; B05D 1/02; B05D 1/28; B05D 1/18; B05D 3/00; B05D 1/00

(52) U.S. Cl. CPC C09D 183/04; B05D 3/007; B05D 1/005; B05D 1/28; B05D 1/18; B05D 1/02

(57) ABSTRACT

An organosililane and a metal alkoxide mixed together at a given molar ratio are subjected to co-hydrolysis and polycondensation in a solution containing an organic solvent, water and a catalyst to obtain a precursor solution with a controlled inter-organosilane distance. The precursor solution is coated onto a solid surface, and then allowed to stand at room temperature under atmospheric pressure for a given time to obtain an organic/inorganic transparent hybrid film. A difference (hysteresis) between the advancing and receding contact angles of the hybrid film relative to a liquid having a surface tension of 18 to 73 dynes/cm has a smaller value than that of a surface treated by the organosilane alone. The hybrid film is improved in terms of adhesion, transparency, and the mobility of functional groups derived from the organosilane on the film surface. A solid surface can be covered by the organic/inorganic transparent hybrid film.

### FIELD OF THE INVENTION

The present invention relates generally to an organic/inorganic transparent hybrid films, and a process for producing them. More particularly, the invention relates to an organic/inorganic transparent film that is obtained by coating a precursor solution prepared by cohydrolysis and polycondensation of an organosilane and a metal alkoxide in a solution containing an organic solvent, water and a catalyst onto the surface of a solid comprising a substrate such as a metal, a metal oxide film, a metal oxide, an alloy, a semiconductor, a polymer, a ceramics, a glass, a resin, a wood, a paper or a fiber to form a transparent film of improved adhesion, simultaneously with volatilization of the solvent, while controlling the mobility of functional groups derived from the organosilane on the surface of the transparent film, and that allows the surface of the substrate to have a variety of improved properties such as water repellency/oil repellency, ability of liquid droplets to roll off, anti-fingerprint properties, defogging properties, corrosion resistance and durability, and a process for producing the same.

The present invention provides a novel technique and a novel product relating to a new surface modification technology because by formation on the surface of the substrate of an organic/inorganic transparent film having a variety of improved properties such as adhesion to substrates, water repellency/oil repellency, ability of liquid droplets to roll off, anti-fingerprint properties, defogging properties, corrosion resistance and durability, they produce notable effects in the automobile and construction material glass fields and other applications where it is typically desired to improve raindrop removal capability and defogging properties thereby making sure the field of vision and preventing sticking of stain, dirt or the like, prevent corrosion of metal materials and wood-based materials, improve releasability of materials out of nanoimprinting molds, and impart anti-fingerprint properties to touch panel displays, etc.

### BACKGROUND ART

As liquid droplets deposit onto the surface of a solid, it sets off corrosion, degradation and pollution of the solid surface from there, and as liquid droplets deposit onto a glass or other transparent material, it gives rise to poor visibility; development of materials and surface treatments having high liquid droplets removal capability have been tried in many engineering fields.

The dynamic behavior (dynamic dewettability) in particular of liquid droplets on a solid surface has recently been increasingly valued in as an index to droplets removal performance, and that behavior may be estimated in terms of contact angle hysteresis (Non-Patent Publication 1). Hysteresis may be represented by a difference (θ_{A}−θ_{R}) between the advancing contact angle (θ_{A}) and the receding contact angle (θ_{R}); the smaller the value, the more likely the liquid droplets are to roll off the solid surface even upon a bit of tilting. In other words, a solid surface having a small hysteresis will have high droplets removal performance. On a solid surface having a large hysteresis, on the other hand, liquid droplets are “pinned down”, and this holds true even for an ultra-water repellent surface having a static contact angle greater than 150°.

For instance, water repellent treatment of a hydrophilic glass or other solid surface is now increasingly practiced using an organosilane terminated with a functional group of low surface energy such as an alkyl group or a perfluoroalkyl group. However, minuscule water droplets have been known to remain on a solid surface even when there is an angle of tilt greater than 90°; so it has been found that such water repellent treatment does not always result in improvements in water droplets removal performance.

Recent, if not many, reports have indicated that the density and dynamic behavior of functional groups grafted to a solid surface have some considerable influences on dynamic dewettability. For instance, McCarthy et al. have investigated a hysteresis change due to a density change of trimethylsilyl groups grafted by vapor treatment onto a silicon substrate, and have discovered that there is the optimum density at which there is the smallest hysteresis present (Non-Patent Publication 2).

This has been interpreted as follows: when the density of the grafted trimethylsilyl groups is higher than the optimum, their mobility becomes low due to too short intermolecular distances, resulting in a large hysteresis, and when the density of the grafted trimethylsilyl groups is low, a portion of the solid surface not covered by trimethylsilyl groups is exposed to give rise to strong interactions between liquid droplets and polar functional groups on the solid surface, ending up with a large hysteresis.

McCarthy et al. as well as the inventors have made use of vapor treatment to graft onto a solid surface branched bulky molecules (for instance, tris(trimethylsiloxy)sylylethylenedimethylsilane (Non-Patent Publication 3), bis(tridecafluoro-1,1,2,2-tetrahydrooctyl)-dimethylsiloxy)methylsilane (Patent Publication 1 and Non-Patent Publication 4), and cyclic molecules (tetramethylcyclotetrasiloxane (Non-Patent Publication 5)), resulting successfully in the creation of a solid surface of very small hysteresis. Such a solid surface having high liquid droplet removal performance is achieved by the “molecular umbrella effect” coming out of the bulkiness of the grafted functional groups.

From these reports, it has been appreciated that bringing the mobility (or fluidity) of functional groups grafted onto a solid surface close to “liquid-like” would be important for the purpose of improving the dynamic dewettability of the solid surface; there is a demand for solid surface treatment capable of achieving such a “liquid-like” state. However, most studies have placed emphasis on a search for molecules capable of dynamic dewettability improvements; there is no or little study case of making use of existing surface treating agents or functional molecules having functional groups with a view to dynamic dewettability improvements.

Problems with the surface modification methods as described above are that 1) there is some limitation on the type of substrates to be treated thanks to a difference in reactivity between an organosilane compound and the substrate surface, 2) the raw materials to be used are limited to a bulky organosilane compound or polymer having a branched/cyclic structure, and 3) a molecular film, because of being a few nm in thickness, may peel off or be damaged for some chemical or physical reasons, and maintenance of surface functions over an extended period of time may be difficult. In the field to which the invention pertains, there is still a mounting demand for development of a surface modification method capable of achieving stable liquid droplet removal performance, corrosion resistance, water repellency/oil repellency in combination with the surfaces of practical substrates in a stable manner over an extended period of time.

### LISTING OF PRIOR ARTS

### Patent Publications

Patent Publication 1: JP(A) 2010-222703

### Non-Patent Publications

Non-Patent Publication 1: L. Gao and T. J. McCarthy, Langmuir, 22, 6234(1999)
Non-Patent Publication 2: Z. Fadeev and T. J. McCarthy, Langmuir, 15, 3759(2006)
Non-Patent Publication 3: Z. Fadeev and T. J. McCarthy, Langmuir, 15, 7328(1999)
Non-Patent Publication 4: A. Hozumi and T. J. McCarthy, Langmuir, 26, 2567(2010)
Non-Patent Publication 5: A. Hozumi, Chen, D. F. and M. Yagihashi, J. Colloid Interface Sci., 353, 582(2011)

### SUMMARY OF THE INVENTION

### Objects of the Invention

Situations being like this and with the prior art in mind, the inventors have devoted themselves to studies with a view to developing an unheard-of, new surface treatment technique for practical substrates that makes it possible to form metal surfaces or glass surfaces having no or little hysteresis, resulting in a discovery of a novel finding that a precursor solution obtained by co-hydrolysis and polycondensation of an organosilane and a metal alkoxide in a solution containing an organic solvent, water and a catalyst is coated onto the surface of a substrate and allowed to stand at room temperature under atmospheric pressure for a given time, whereby 1) simultaneously with volatilization of the solvent, there is a transparent film of improved adhesion formed, and 2) the surface of the transparent film obtained in 1) is by far smaller in hysteresis than the surface of a substrate covered by a monolayered film composed of the same organosilane molecules. Further, the inventors have made study after study to bring the invention up to completion.

An object of the invention is to provide a novel surface modification technique wherein as compared with coating of a monolayered film of an organosilane onto a substrate (there was usually a hysteresis of 10° or more occurred), a transparent organic/inorganic hybrid film is formed by coating only, and the resulting solid surface has a very small hysteresis relative to a liquid having a surface tension of 18 to 73 dynes/cm. Another object of the invention is to provide a surface modification technique capable of forming a surface having a very small hysteresis: a surface having a value of a contact angle hysteresis (θ_{A}−θ_{R}) smaller than that of a surface treated by the organosilane alone as measured in terms of a dynamic contact angle (an advancing contact angle (θ_{A}) and a receding contact angle (θ_{R})).

Yet another object of the invention is to provide a new technique and a new product relating to a very useful, novel surface modification technology for industrial applications where it is typically desired to reduce or minimize the interactions between liquid droplets and a solid surface, thereby to improve the ability of automotive glass and construction material glass to remove raindrops and to defog and keep them clean for the field of vision and prevention of sticking of dirt, stain or the like, control water flows through μ-TAS, biochips or the like, control micro-water drops through nozzles, etc. for water-soluble ink jets, prevent corrosion of metals and wood-based materials, improve the releasability of materials out of nanoimprinting molds, impart anti-fingerprint properties to touch panel displays, and so on.

### Means for Accomplishing the Objects

The invention having for its objects to solve the prior art problems comprises the following technical means.
(1) An organic/inorganic transparent hybrid film formed on a solid surface, characterized in that said film is a film obtained by co-hydrolysis and polycondensation of an organosilane and a metal alkoxide mixed together at a given molar ratio in a solution containing an organic solvent, water and a catalyst, and ensures that a dynamic dewettability of the solid surface, or a contact angle hysteresis (θ_{A}−θ_{R}) of the solid surface as measured, where θ_{A} is an advancing contact angle and θ_{R} is a receding angle, has a value smaller than that of a surface treated by the organosilane alone.
(2) An organic/inorganic transparent hybrid film as recited in (1), wherein said film ensures that a difference (hysteresis) between the advancing contact angle and the receding contact angle relative to a liquid having a surface tension of 18 to 73 dynes/cm has a value smaller than that of a surface treated by the organosilane alone.
(3) An organic/inorganic transparent hybrid film as recited in (1), wherein the organosilane and the metal alkoxide are mixed together at a molar ratio of 1:0.1 or greater.
(4) An organic/inorganic transparent hybrid film as recited in any one of (1) to (3), wherein the obtained organic/inorganic transparent hybrid film is free of any regular structure or has a layer structure with an interlayer distance of 1 to 10 nm.
(5) An organic/inorganic transparent hybrid film as recited in any one of (1) to (4), wherein said film has adhesion enough to adhere to a substrate selected from within the group consisting of a metal, a metal oxide film, an alloy, a semiconductor, a polymer, a ceramics, a glass, a resin, a wood, a fiber and a paper.
(6) An organic/inorganic transparent hybrid film as recited in any one of (1) to (5), wherein said film has adhesion enough to adhere to a hybrid surface composed of at least one selected from the group consisting of a planar surface, a curved surface, a concave/convex surface and a porous surface.
(7) An organic/inorganic transparent hybrid film as recited in any one of (1) to (6), wherein there is a variable distance between the neighboring alkyl chains depending on the molar ratio between the organosilane and the metal alkoxide.
(8) An organic/inorganic transparent hybrid film as recited in any one of (1) to (7), wherein the difference (hysteresis) between the advancing contact angle and the receding contact angle relative to a hybrid liquid of the liquid recited in (1) with at least one compound has a value smaller than that of the surface treated by the organosilane alone.
(9) An organic/inorganic transparent hybrid film as recited in any one of (1) to (7), wherein said film is less capable of fingerprint adhesion, and fingerprints are easily wiped off even once adhering to it.
(10) An organic/inorganic transparent hybrid film as recited in any one of (1) to (7), wherein when a film surface is at a temperature lower than a dew point, water droplets deposited by dew condensation onto the surface are wettingly spread over the film surface to form a thin water film having de-misting capability.
(11) An organic/inorganic transparent hybrid film as recited in any one of (1) to (7), wherein when there is damage to the surface and the difference (hysteresis) between the advancing contact angle and the receding contact angle increases up to an incalculatable level, the damaged surface is removed to expose a new surface with the difference (hysteresis) between the advancing contact angle and the receding contact angle having a value smaller than that of a surface treated by the organosilane alone.
(12) An organic/inorganic transparent hybrid film as recited in any one of (1) to (7), wherein the organosilane that provides a raw material of the organic/inorganic transparent hybrid film is represented by the following formula (A): R¹—Si—R²₃₋ₙR³ₙ where n is equal to 1, 2 or 3, R¹ stands for an alkyl chain having 1 to 30 carbon atoms or a perfluoro group having 1 to 20 carbon atoms, R² stands for an alkyl group having 1 to 6 carbon atoms, and R³ stands for an alkoxy group having 1 to 15 carbon atoms, a chloro group, an isocyanato group or an acetoxy group, and includes an inert functional group bound via an Si—C bond and a functional group forming at least one Si—OH group after hydrolysis.
(13) An organic/inorganic transparent hybrid film as recited in any one of (1) to (7), wherein the organosilane that provides a raw material of said organic/inorganic transparent hybrid film is represented by the following formula (B): R¹R²—Si—R³ₙR⁴₃₋ₙ where n is equal to 1, 2 or 3, R¹ stands for a hydroxyl group, a vinyl group, an alkyl chloride group, an amino group, an imino group, a nitro group, a mercapto group, an epoxy group, a carbonyl group, a methacryloxy group, an azido group, a diazo group or a benzopheny group and a derivative thereof, R² stands for an alkylene group having 1 to 15 carbon atoms (—CₙH₂ₙ—), R³ stands for an alkyl group having 1 to 6 carbon atoms, and R⁴ stands for an alkoxy group having 1 to 15 carbon atoms, a chloro group, an isocyanato group or an acetoxy group, and includes an active functional group bound via an Si—C bond and a functional group forming at least one Si—OH group after hydrolysis.
(14) An organic/inorganic transparent hybrid film as recited in any one of (1) to (7), wherein at least two selected from the organosilanes recited in (13) is used as a raw material of an organosilane that provides a raw material of the organic/inorganic transparent hybrid film.
(15) An organic/inorganic transparent hybrid film as recited in any one of (1) to (7), wherein the metal alkoxide providing a raw material of the organic/inorganic transparent hybrid film is represented by the following formula (C): M(R¹)ₙ where n is equal to 1, 2, 3 or 4, M stands for a metal element Al, Ca, Fe, Ge, Hf, In, Si, Ta, Ti, Sn, or Zr, and R stands for an alkoxy group having 1 to 15 carbon atoms.
(16) An organic/inorganic transparent hybrid film as recited in any one of (1) to (7), wherein at least two selected from the metal alkoxides recited in (15) are used as a raw material of the metal alkoxide providing a raw material of the organic/inorganic transparent hybrid film.
(17) An organic/inorganic transparent hybrid film as recited in any one of (1) to (7), wherein the organosilane is replaced by an organic carboxylic acid or an organic phosphonic acid represented by the following formula (D): R¹-R² where R¹ stands for an alkyl chain having 1 to 30 carbon atoms or a perfluoroakyl group having 1 to 20 carbon atoms (CF₃(CF₂)ₙ— where n is equal to 0 to 19, and R² stands for carboxyl (—COOH), phosphonic acid (—P(O)(OH)₂), or phosphoric acid (—O—P(O)(OH)₂)).
(18) A method for producing an organic/inorganic transparent hybrid film, characterized by coating a precursor solution obtained by co-hydrolysis and polycondensation of an organosilane and a metal alkoxide mixed together at a given molar ratio in a solution containing an organic solvent, water and a catalyst, with a controlled inter-organosilane distance, onto a surface of a solid selected from within the group consisting of a metal, a metal oxide film, an alloy, a semiconductor, a polymer, a ceramics, a glass, a resin, a wood, a paper and a fiber, and then evaporating the solvent at room temperature under atmospheric pressure for a given time to allow for crosslinkage of the resulting film.
(19) A method for producing an organic/inorganic transparent hybrid film as recited in (18), which makes use of an organic solvent that is miscible with water used for the hydrolysis, is capable of dissolving a substance obtained after the hydrolysis and polycondensation of the organosilane and metal alkoxide, and has a vapor pressure higher than that of water.
(20) A method for producing an organic/inorganic transparent hybrid film as recited in (18) or (19), wherein the catalyst used for the hydrolysis has an action on acceleration of hydrolysis of R³ in formula (A), R⁴ in formula (B) and R¹ in formula (C).
(21) A method for producing an organic/inorganic transparent hybrid film as recited in any one of (18) or (20), wherein the volatilization of the organic solvent is accelerated by any one of a spin coating process, a dip coating process, a roller coating process, a bar coating process, an ink jet coating process, a gravure coating processing, a spraying process, a dispenser process, a nozzle coating process, a slit coating process, a die coating process, a blade coating process, a knife coating process, a wire bar coating process or a screen printing process.
(22) A method for producing an organic/inorganic transparent hybrid film as recited in any one of (18) to (21), wherein a film thickness is controlled between 10 nm and 10,000 nm depending on a molar concentration of the organic solvent relative to a concentration of the organosilane and metal alkoxide in the precursor solution.
(23) A method for producing an organic/inorganic transparent hybrid film as recited in any one of (18) or (22), wherein the prepared precursor solution is usable even after 180 days storage.
(24) A solid surface, characterized in that said solid surface is a solid surface coated with an organic/inorganic transparent hybrid film as recited in any one of (1) to (7), said solid surface having water repellency/oil repellency, ability of liquid droplets to roll off, liquid droplet removal capability, anti-fingerprint properties, defogging properties, and corrosion resistance.

The invention will now be explained in further details.

The present invention provides an organic/inorganic transparent hybrid film, characterized in that it is a film obtained by co-hydrolysis and polycondensation of an organosilane and a metal alkoxide mixed together at a given molar ratio in a solution containing an organic solvent, water and a catalyst, said film ensuring that a difference (hysteresis) between the advancing contact angle and the receding contact angle relative to a liquid having a surface tension of 18 to 73 dynes/cm has a smaller value than that of a surface treated by the organosilane alone. The present invention also provides a method for producing a transparent organic/inorganic hybrid film, characterized by subjecting an organosilane and a metal alkoxide to co-hydrolysis and polycondensation in a solution containing an organic solvent, water and a catalyst to form a precursor solution with a controlled inter-organosilane distance, coating the precursor solution onto a solid surface, and allowing the solid surface to stand at room temperature under atmospheric pressure for a given time for volatilization of the solvent and cross-linkage of the resulting film. Further, the present invention provides a solid surface coated with the aforesaid organic/inorganic transparent hybrid film, characterized by having improved water repellency/oil repellency, ability of liquid droplets to roll off, liquid droplet removal capability, anti-fingerprint properties, defogging properties and corrosion resistance.

The invention embodied as described above makes sure formation of an organic/inorganic transparent hybrid film improved in terms of adhesion and mobility of functional groups derived from the organosilane on the film surface, so that the difference (hysteresis) between the advancing and receding contact angles relative to various liquid droplets (having a surface tension of 18 to 37 dynes/cm) and a mixed liquid comprising a mixture of two or more of these liquids can have a value smaller than that of a surface treated by the organosilane alone.

In preferable embodiments of the invention, the organosilane and metal alkoxide are mixed together at any molar ratio of 1:0.1 or more, and more preferably 1:0.1 to 100; the resultant organic/inorganic transparent hybrid film has adhesion good enough to adhere readily to a substrate selected from within the group consisting of a metal, a metal oxide film, an alloy, a semiconductor, a polymer, a ceramics, a glass, a resin, a wood, a fiber and a paper; and the aforesaid film has adhesion good enough to adhere to a hybrid surface composed of at least one surface selected from within the group consisting of a planar surface, a curved surface, a concave/convex surface and a porous surface.

In preferable embodiments of the invention, there is a change in the inter-organosilane distance depending on the molar ratio between the organosilane and the metal alkoxide; the difference (hysteresis) between the advancing and receding contact angles of the surface of the aforesaid organic/inorganic transparent hybrid film relative to various liquid droplets (having a surface tension of 18 to 73 dynes/cm), a mixture of at least two of these liquids or a hybrid surface of these liquids hybridized with a solid(s) has a value smaller than that of a surface treated by the organosilane alone or fingerprints are less likely to adhere to it; the organic/inorganic transparent hybrid film has de-misting capability; and when there is damage to the surface to such an extent that the difference (hysteresis) between the advancing and receding contact angles increases or is incalculatable, the damaged surface is removed off to expose a new surface with a difference (hysteresis) between the advancing and receding contact angles having a value smaller than that of a surface treated by the organosilane alone.

In the invention, it is preferable that the organo-silane that provides a raw material of the organic/inorganic transparent hybrid film is represented by the following formula (A): R¹—Si—R²₃₋ₙR³ₙ where n is equal to 1, 2 or 3, R¹ stands for an alkyl chain having 1 to 30 carbon atoms or a perfluoro group having 1 to 20 carbon atoms, R² stands for an alkyl group having 1 to 6 carbon atoms, and R³ stands for an alkoxy group having 1 to 15 carbon atoms, a chloro group, an isocyanato group or an acetoxy group and that includes an inert functional group bound via an Si—C bond and a functional group forming at least one Si—OH group after hydrolysis, or the following formula (B): R¹R²—Si—R³ₙR⁴₃₋ₙ where n is equal to 1, 2 or 3, R¹ stands for a hydroxyl group, a vinyl group, an alkyl chloride group, an amino group, an imino group, a nitro group, a mercapto group, an epoxy group, a carbonyl group, a methacryloxy group, an azido group, a diazo group or a benzopheny group and a derivative thereof, R² stands for an alkylene group having 1 to 15 carbon atoms (—CₙH2ₙ—), R³ stands for an alkyl group having 1 to 6 carbon atoms, and R⁴ stands for an alkoxy group having 1 to 15 carbon atoms, a chloro group, an isocyanato group or an acetoxy group, and that includes an active functional group bound via an Si—C bond and a functional group forming at least one Si—OH group after hydrolysis.

In the invention, it is preferable that the metal alkoxide that provides a raw material of the organic/inorganic transparent hybrid film is represented by the following formula (C): M(R¹)ₙ where n is equal to 1, 2, 3 or 4, M stands for a metal element Al, Ca, Fe, Ge, Hf, In, Si, Ta, Ti, Sn, or Zr, and R stands for an alkoxy group having 1 to 15 carbon atoms.

In the invention, a precursor solution obtained by co-hydrolysis and polycondensation of an organosilane and a metal alkoxide in a solution containing an organic solvent, water and a catalyst is added dropwise to the surface of a solid selected from within the group consisting of a metal, a metal oxide film, an alloy, a semiconductor, a polymer, a ceramics, a glass, a resin, a wood, a paper and a fiber, and then allowed to stand at room temperature under atmospheric pressure for a given time for volatilization of the solvent. In the invention, it is preferable that there is an organic solvent used, which solvent is miscible with a small amount of water used for the hydrolysis, can dissolve a substance after the hydrolysis and polycondensation of the organosilane and metal alkoxide, and has a vapor pressure higher than that of water, and that the molar fraction of water used for the hydrolysis is greater than that of the alkoxy group in the precursor solution composition.

In the invention, the catalyst used for the hydrolysis includes a catalyst having an action on acceleration of hydrolysis of R³ in the aforesaid formula (A), R⁴ in the aforesaid formula (B) and R¹ in the aforesaid formula (C). In the invention, it is preferable that the volatilization of the solvent is accelerated by any one process selected from within the group consisting of a spin coating process, a dip coating process, a roller coating process, a bar coating process, an ink jet coating process, a gravure coating process, and a spraying process, and that a film thickness is controlled between 10 nm and 10,000 nm depending on the concentration of the organosilane and metal alkoxide in the precursor solution.

While the organosilane that may be used herein, for instance, is preferably an alkyl (3 to 18 carbon atoms) alkoxysilane or the like, it is to be appreciated that any other organosilanes may similarly be used with the proviso that they are equal or similar in effect thereto. By way of example, these organosilanes include such compounds as mentioned below.

By way of example but not by way of limitation, the organosilanes include an alkyl (having 1 to 30 carbon atoms) trimethoxysilane, an alkyl (having 1 to 30 carbon atoms) triethoxysilane, an alkyl (having 1 to 30 carbon atoms) methyldimethoxysilane, an alkyl (having 1 to 30 carbon atoms) methyldiethoxysilane, an alkyl (having 1 to 30 carbon atoms) dimethyldimethoxysilane, an alkyl (having 1 to 30 carbon atoms) dimethylethoxysilane, an alkyl (having 1 to 30 carbon atoms) trichlorosilane, an alkyl (having 1 to 30 carbon atoms) methyldichlorosilane, an alkyl (having 1 to 30 carbon atoms) dimethylchlorosilane, an alkyl (having 1 to 30 carbon atoms) triacetoxysilane, an alkyl (having 1 to 30 carbon atoms) methyldiacetoxy-silane, an alkyl (having 1 to 30 carbon atoms) dimethylacetoxysilane, an alkyl (having 1 to 30 carbon atoms) triisocyanatosilane, an alkyl (having 1 to 30 carbon atoms) methyldicyanatosilane, an alkyl (having 1 to 30 carbon atoms) dimethylcyanatosilane, a perfluoro (having 3 to 18 carbon atoms) trimethoxysilane, a perfluoro (having 3 to 18 carbon atoms) triethoxysilane, a perfluoro (having 3 to 18 carbon atoms) methyldi-methoxsilane, a perfluoro (having 3 to 18 carbon atoms) dimethylethoxysilane, a perfluoro (having 3 to 18 carbon atoms) trichlorosilane, a perfluoro (having 3 to 18 carbon atoms) methyldichlorosilane, a perfluoro (having 3 to 18 carbon atoms) dimethylchlorosilane, a perfluoro (having 3 to 18 carbon atoms) triacetoxysilane, a perfluoro (having 3 to 18 carbon atoms) methyldi-acetoxysilane, a perfluoro (having 3 to 18 carbon atoms) dimethylacetoxysilane, a perfluoro (having 3 to 18 carbon atoms) triisocyanatosilane, a perfluoro (having 3 to 18 carbon atoms) methyldicyanatosilane, and a perfluoro (having 3 to 18 carbon atoms) dimethylcyanatosilane.

The metal alkoxide usable herein may include, but not limited to, ones known so far in the art. By way of example, metal alkoxides including two or more alkoxy groups with a metal element as center, except those mentioned in [0026], may be used, and the following compounds having the same or similar effects may be used as well.

By way of example only, the metal alkoxides include tetramethoxysilane, tetraethoxysilane, tetra-n-propoxysilane, tetra-n-propoxysilane, tetra-n-butoxysilane, tetra-t-butoxysilane, triethoxyaluminum, tri-n-propoxyaluminum, tri-i-propoxyaluminum, tri-n-butoxyaluminum, tri-t-butoxyaluminun, dimethoxycalcium, diethoxycalcium, di-i-propoxycalcium, di-n-butoxycalcium, triethoxy iron, tetramethoxygermanium, tetraethoxy-germanium, tetra-i-propoxygermanium, tetra-n-butoxygermanium, tetra-t-butoxygermanium, tetramethoxyhafnium, tetraethoxyhafnium, tetra-i-propoxyhafnium, tetra-n-butoxyhafnium, tetra-t-butoxyhafnium, trimethoxyindium, triethoxyindium, tri-i-propoxyindium, tri-n-butoxyindium, tri-t-butoxyindium, pentamethoxytantalum, pentaethoxy-tantalum, penta-i-propoxytantalumn, penta-t-butoxytantalum, penta-n-butoxytantalum, tetramethoxytitanium, tetraetoxytitanium, tetra-i-propoxytitanium, tetra-n-butoxytitanium, tetra-t-butoxytitanium, tetramethoxytin, tetraethoxytin, tetra-i-propoxytin, tetra-n-butoxytin, and tetra-t-butoxytin.

In order to form a transparent yet uniform film according to the invention, it is preferable that the organic solvent is miscible with a small amount of water, can dissolve a polycondensation product of the organosilane and metal alkoxide, and is rapidly volatilized off upon coating of the precursor solution onto the substrate. In other words, it is preferable that the precursor solution is prepared using an organic solvent having a vapor pressure higher than that of water such as methanol, ethanol, isopropanol, and tetrahydro-furan.

If the concentrations of the organosilane and metal alkoxide are adjusted, it is then possible to control the film thickness between 10 nm and 10,000 nm. This is because when a certain amount of the precursor solution is added dropwise to the surface of the substrate for formation of a film by volatilization of the solvent, the higher the concentrations of the organosilane and metal alkoxide that are solid components contained in the precursor solution, the more solid gets precipitated on the surface of the substrate.

In the invention it is desired to make use of a catalyst for the purpose of accelerated hydrolysis of reactive functional groups of the organosilane and metal alkoxide (formation of M-OH groups where M is a metal element). It is also desirable to control the pH of the precursor solution by that catalyst thereby stabilizing the polycondensation product of the organo-silane and metal alkoxide. For instance, when there is an alkoxysilyl group used, it is preferable to use an acid such as hydrochloric acid thereby adjusting pH to 1 to 3.

The amount of water to be added should preferably be greater than the number of functional groups for the purpose of hydrolyzing all of reactive functional groups contained in the precursor solution to form M-OH groups where M is a metal element. An amount of water less than defined above may result in the formation of a film, but it is not preferable because insufficient hydrolysis will cause an unhydrolyzed portion of the organosilane and metal alkoxide to be volatilized during treatment, leading to poor yields.

In the precursor solution during the hydrolysis and polycondensation, a portion of the organo-silane and metal alkoxide after the hydrolysis undergoes random polycondensation. This is because the post-hydrolysis metal alkoxide and the post-polycondensation organosilane are subjected to alternate polycondensation, spacing the organic groups derived from the organosilane away from each other.

It follows that the metal alkoxide behaves as a “spacer” to space the organic groups of the organosilane away from each other. FIG. 1 is a schematic view illustrative of use of a long-chain alkyltrimethoxysilane and tetramethoxysilane as the raw materials. As can be seen from FIG. 1, the mobility on the film surface of a substance derived from the organosilane is so improved that a solid surface having a small hysteresis can be obtained.

According to the invention, therefore, it is possible to vary the amount of the metal alkoxide to be added to the organosilane thereby controlling the inter-organosilane distance as desired. It is in turn possible to adjust the mobility on the film surface of the functional groups derived from the organosilane thereby brining the film surface close to the so-called “liquid-like” surface, so resulting in improvements in dynamic dewettability.

In the invention, there is no particular limitation on how to form films provided that there is an acceleration of volatilization of the solvent. For instance, preferable examples include, but not limited to, a spin coating process, a dip coating process, a roller coating process, a bar coating process, an ink jet coating process, a gravure coating process, and a spraying process.

As the substrate usable herein, use may be made, as desired, of appropriate materials such as metals, metal oxide films, alloys, semiconductors, polymers, ceramics, glass, resins, wood, paper and fibers. Specific examples of the substrate include, but not limited to, copper, brass, silicon, polycarbonate, glass, silicone resin,

Japanese cypress, and ribbons. These substrates may be shaped as desired; for instance, they may be in plate, concave/convex, powdery, tubular, porous, fibrous or other forms. There is no need for any pretreatment of the substrate; of course, the substrate may be washed by means of plasma, UV or the like.

In the invention, a layer structure with an interlayer distance of 1 to 10 nm may occur although depending on the type of organosilane, because silanol formed after the hydrolysis of the organosilane has hydrophilicity, whereas the organic groups have hydrophobicity with the result that upon film formation, the polycondensation product of the organosilane and metal alkoxide behaves amphipathically and self-assembles using the hydrophobic interaction of the organic groups as a driving force. The organosilane preferable for formation of such a layer structure, for instance, includes an alkylalkoxysilane having 4 to 18 carbon atoms. Although again depending on the type of organosilane. On the other hand, there may be an amorphous hybrid film formed with no formation of any layer structure, said hybrid film being free from any nanometer order regularity. However, it has been found that whether or not there is regularity has no influence on dynamic dewettability at all.

As described above, the organosilane usable herein, for instance, includes organosilanes having active functional groups in addition to the alkylalkoxysilane. Preferable examples of the organosilane usable herein are vinyltriethoxysilane, and 2-hydroxy-4-(3-triethoxysilyl-propoxy)-diphenylketone. Other organosilanes having active functional groups such as hydroxyl groups, aldehyde groups, alkyl chloride groups, amino groups, imino groups, nitro groups, mercapto groups, epoxy groups, carbonyl groups, methacryloxy groups, azido groups, diazo groups or benzopheny groups may also be used.

Further, the organosilane may be replaced by an organic carboxylic acid or an organic phosphonic acid or compounds represented by the following formula (D) R¹-R² where R¹ stands for an alkyl chain having 1 to 30 carbon atoms or a perfluoroakyl group having 1 to 20 carbon atoms (CF₃(CF₂)ₙ— where n is equal to 0 to 19, and R₂ stands for carboxyl (—COOH), phosphonic acid (—P(O)(OH)₂), or phosphoric acid (—O—P(O)(OH)₂)).

### Advantages of the Invention

The present invention produces such advantages as mentioned below.
(1) There is a new surface modification technique developed to give a surface having a very small hysteresis to a surface of a substrate using an organosilane having inert functional groups, for instance, a long-chain alkyltriethoxysilane.
(2) There is a new surface modification technique developed to give a surface having a very small hysteresis to a surface of a substrate using an organosilane having active functional groups, for instance, vinyltriethoxysilane, 2-hydroxy-4-(3-triethoxysilylpropoxy)-diphenylketone, etc.
(3) There is a surface modification technique provided, which enables the dynamic dewettability of a surface of a substrate, viz., the contact angle hysteresis (θ_{A}−θ_{R}), where θ_{A} is the advancing contact angle and θ_{R} is the receding contact angle, upon measurement of the dynamic contact angle to have a value smaller than that of a treated by the organosilane alone so that a surface having a very small hysteresis can be obtained.
(4) The thickness of the film is controllable between 10 nm and 10,000 nm depending on the concentration of the organosilane and metal alkoxide relative to the organic solvent.
(5) Further, there is a surface treatment technique provided that enables an organic/inorganic hybrid film having a very small hysteresis relative to a liquid having a surface tension of 18 to 73 dynes/cm to be formed on a substrate with good enough adhesion to it, but without imposing limitation on selection of substrates and without applying any pretreatment to it.
(6) High transparency of the organic/inorganic hybrid film allows for surface treatment of the substrate of interest while keeping the appearance of the surface of the substrate intact and without detrimental to the design.
(7) The post-preparation precursor solution is stable so much so that it can be stored over an extended period of time.
(8) The hybrid film of the invention is curable at room temperature with no application of special heat treatment so much so that it can be formed on polymers, paper, resin, wood or like other materials having a low heat resistance temperature.
(9) The film is adjustable as desired in terms of hardness and flexibility by adjustment of the content of the organosilane so much so that it can be applied to a sheet-form polymer, a metal film, paper or the like without giving rise to cracking or peeling even upon bending.
(10) Making sure the improved dynamic dewettability of the organic/inorganic transparent hybrid film, the present invention provides a very useful, new surface modification technique for industrial applications where it is typically desired to improve the ability of automotive glass and construction material glass to remove raindrops and to defog and keep them clean for the field of vision and prevention of sticking of dirt, stain or the like, control water flows through μ-TAS, biochips or the like, control micro-water drops through nozzles, etc. for water-soluble ink jets, prevent corrosion of metals and wood-based materials, improve the releasability of materials out of nanoimprinting molds, impart anti-fingerprint properties on touch panel displays, and so on.

### BRIEF EXPLANATION OF THE DRAWINGS

FIG. 1 is illustrative in schematic of what state the organosilane and metal alkoxide are placed in during co-hydrolysis and polycondensation and what state a film is in after its formation. By addition of the metal alkoxide, the distance between organic groups (R) derived from the organosilane gets longer as compared with when there is no addition of the metal alkoxide, resulting in improvements in the mobility of the organic sites (R).

FIG. 2 is illustrative of the appearance of a glass tube in Example 3, and Comparative Example 3 after n-hexadecane stained by Sudan III was added dropwise to it.

FIG. 3 is illustrative of the appearance of a sample in Example 6, and Comparative Example 6 against which fingerprints were pressed.

FIG. 4 is illustrative of the appearance of a sample in Example 7, and Comparative Example 7 after it was exposed to vapor.

FIG. 5 is indicative of the XRD patterns of various samples in Example 12.

FIG. 6 is indicative of the XRD pattern of a sample ZrCA₁₈ in Example 14.

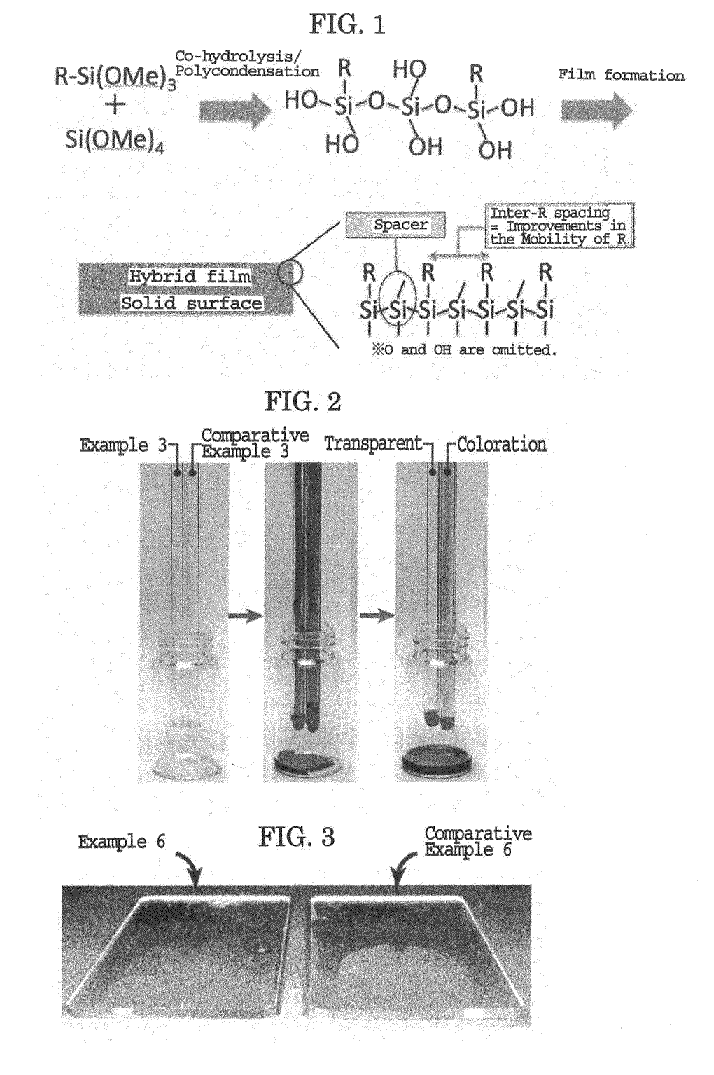

### MODES FOR CARRYING OUT THE INVENTION

While the present invention will now be explained with reference to specific examples, it is to be noted that the following examples are given for the purpose of illustration alone, but not by way of limitation.

### Example 1

Various organosilanes and metal alkoxides (mainly tetramethoxysilane) were mixed together at given ratios (Table 1), and the mixtures were blended with ethanol and hydrochloric acid before the blends were stirred at room temperature for a given time. The obtained solution was spin coated onto a glass substrate, and then allowed to stand at room temperature for one day.

The values of the advancing (θA) and receding (θR) contact angles and hysteresis of various samples relative to Milli-Q water and n-hexadecane in Example 1 are tabulated in Table 1. As shown in Table 1, it has been confirmed that surfaces having a small hysteresis are formed over a wide range of molar ratios (metal alkoxide/organosilane=0.1 to 100).

TABLE 1

| | | | | Milli-Q water | | | n-hexadecane | | |
|---|---|---|---|---|---|---|---|---|---|
| | | | Metal | | Receding | | | Receding | |
| | | Metal alkoxide | alkoxide/ | Advancing | Contact | | Advancing | Contact | |
| Organosilane | | Name of the | Organosilane | Contact | Angle | Hysteresis | Contact | Angle | Hysteresis |
| Name of the Compound | CAS | Compound | Molar ratio | Angle(°) | (°) | (°) | Angle (°) | (°) | (°) |
| Octadecyltriethoxysilane | 7399- | Tetraethoxysilane | 8.00 | 115.9 | 108.1 | 7.8 | 44.1 | 38.7 | 5.4 |
| | 00-0 | | | | | | | | |
| Hexadecyltriethoxysilane | 16415- | Tetraethoxysilane | 15.00 | 116.0 | 104.3 | 11.8 | 42.8 | 32.9 | 9.6 |
| | 13-7 | | | | | | | | |
| Tetradecyltriethoxysilane | 16153- | Tetraethoxysilane | 6.00 | 112.1 | 101.7 | 10.4 | 47.0 | 38.9 | 8.1 |
| | 27-8 | | | | | | | | |
| Dodecyltriethoxysilane | 18536- | Tetraethoxysilane | 2.00 | 113.8 | 106.0 | 7.7 | 49.2 | 43.5 | 5.7 |
| | 91-9 | | 3.00 | 108.9 | 102.9 | 5.9 | 38.0 | 35.0 | 3.0 |
| | | | 4.00 | 108.3 | 101.7 | 6.5 | 31.8 | 29.0 | 2.8 |
| | | | 5.00 | 107.2 | 98.8 | 8.4 | 23.5 | 21.2 | 2.4 |
| | | | 6.00 | 100.2 | 91.5 | 8.7 | 13.1 | 11.3 | 1.8 |
| | | | 7.00 | 91.3 | 87.8 | 3.5 | 8.9 | 4.6 | 4.3 |
| | | | 8.00 | 93.8 | 85.2 | 8.6 | 9.3 | 3.1 | 6.2 |
| Decyltriethoxysilane | 2943- | Tetraethoxysilane | 4.00 | 112.0 | 102.8 | 9.2 | 38.8 | 37.6 | 1.2 |
| | 73-9 | | 5.00 | 109.4 | 95.0 | 14.5 | 37.5 | 35.7 | 1.8 |
| | | | 6.00 | 111.3 | 99.7 | 11.6 | 36.5 | 34.5 | 2.1 |
| | | | 7.00 | 110.3 | 99.5 | 10.7 | 35.0 | 33.3 | 1.7 |
| | | | 8.00 | 109.6 | 100.3 | 9.3 | 32.4 | 32.0 | 0.4 |
| | | | 9.00 | 109.6 | 101.1 | 8.5 | 35.4 | 33.6 | 1.8 |
| | | | 10.00 | 111.7 | 102.9 | 8.8 | 35.1 | 33.5 | 1.5 |
| | | | 11.00 | 111.6 | 102.1 | 9.6 | 34.2 | 32.3 | 2.0 |
| | | | 12.00 | 110.2 | 102.2 | 8.0 | 33.5 | 32.2 | 1.2 |
| | | | 13.00 | 110.2 | 102.2 | 8.0 | 31.4 | 31.2 | 0.2 |
| | | | 14.00 | 109.7 | 101.1 | 8.6 | 30.6 | 29.9 | 0.7 |
| | | | 15.00 | 108.5 | 102.5 | 6.0 | 30.6 | 28.7 | 1.9 |
| | | | 16.00 | 108.6 | 99.7 | 8.9 | 28.8 | 28.7 | 0.1 |
| | | | 17.00 | 107.2 | 99.3 | 7.9 | 28.2 | 26.7 | 1.6 |
| | | | 50.00 | 111.8 | 100.7 | 11.1 | 34.3 | 32.5 | 1.8 |
| | | | 100.00 | 110.3 | 107.5 | 2.8 | 37.5 | 36.6 | 0.9 |
| Octyltriethoxysilane | 2943- | Tetraethoxysilane | 2.00 | 108.6 | 100.8 | 7.8 | 38.9 | 37.1 | 1.8 |
| | 75-1 | | 3.00 | 107.3 | 97.3 | 10.0 | 33.6 | 31.8 | 1.8 |
| | | | 4.00 | 102.4 | 96.8 | 5.6 | 28.7 | 25.4 | 3.3 |
| | | | 5.00 | 105.4 | 101.4 | 4.1 | 32.8 | 30.9 | 1.7 |
| | | | 6.00 | 94.4 | 89.0 | 5.4 | 21.2 | 17.8 | 3.4 |
| | | | 7.00 | 92.3 | 85.3 | 7.0 | 19.0 | 16.7 | 2.3 |
| | | | 8.00 | 90.2 | 82.3 | 8.0 | 20.2 | 18.6 | 1.6 |
| Hexyltriethoxysliana | 19165- | Tetraethoxysilane | 1.00 | 111.6 | 105.1 | 6.5 | 40.5 | 37.3 | 3.2 |
| | 37-5 | | 2.00 | 105.0 | 99.3 | 5.7 | 36.4 | 35.1 | 1.2 |
| | | | 3.00 | 102.5 | 95.8 | 6.8 | 32.7 | 31.6 | 1.1 |
| | | | 4.0 | 100.7 | 94.2 | 6.5 | 29.2 | 27.5 | 1.7 |
| | | | 5.0 | 94.6 | 88.3 | 6.4 | 26.1 | 24.6 | 1.5 |
| | | | 6.0 | 92.5 | 84.7 | 7.8 | 25.7 | 23.5 | 2.2 |
| | | | 7.0 | 90.5 | 80.7 | 9.8 | 25.3 | 23.6 | 1.7 |
| | | | 8.0 | 87.3 | 78.0 | 9.3 | 25.4 | 22.0 | 3.5 |
| Propyltriethoxysilane | 2550- | Tetraethoxysilane | 0.5 | 88.1 | 78.6 | 9.5 | 36.2 | 28.2 | 8.0 |
| | 02-9 | | | | | | | | |
| Ethyltriethoxysilane | 78-07-9 | Tetraethoxysilane | 0.10 | 97.6 | 85.6 | 12.0 | 19.3 | 14.1 | 5.2 |
| | | | 0.25 | 99.3 | 88.1 | 11.2 | 28.1 | 20.2 | 7.9 |
| | | | 0.50 | 96.8 | 88.7 | 8.1 | 27.0 | 19.9 | 7.1 |
| Methyltriethoxysilane | 2031 - | Tetraethoxysilane | 0.25 | 89.5 | 85.0 | 4.5 | 42.3 | 36.4 | 5.9 |
| | 67-6 | | 0.50 | 93.3 | 84.9 | 8.4 | 41.3 | 36.2 | 5.2 |
| 3,3,3-Trifluoropropyl- | 429-60- | Tetraethoxysilane | 2.00 | 98.0 | 81.0 | 17.0 | 43.0 | 38.0 | 5.0 |
| trimothoxysilane | 7 | | | | | | | | |
| Nanofluorohexyltriethoxy- | 102390- | Tetraethoxysilane | 5.00 | 110.0 | 91.0 | 19.0 | 63.0 | 57.0 | 6.0 |
| silane | 95-7 | | | | | | | | |
| Tridecafluorooctyltri- | 51851- | Tetraethoxysilane | 7.00 | 113.0 | 94.0 | 19.0 | 63.0 | 59.0 | 4.0 |
| ethoxysilane | 37-7 | | | | | | | | |
| Heptadecafluorooctyl- | 101947- | Tetraethoxysilane | 9.00 | 107.0 | 95.0 | 12.0 | 58.0 | 51.0 | 7.0 |
| triethoxysilane | 16-4 | | | | | | | | |
| Vinyltriethoxysilane | 78-08-0 | Tetraethoxysilane | 0.1 | 30.3 | 25.2 | 5.1 | 30.3 | 25.2 | 5.1 |
| | | | 0.3 | 31.4 | 26.6 | 4.8 | 31.4 | 26.6 | 4.8 |
| | | | 0.5 | 31.1 | 26.5 | 4.6 | 31.1 | 26.5 | 4.6 |
| 2-Hydroxy-4-(3-triethoxysilyl- | 79876- | Tetraethoxysilane | 8.0 | 55.7 | 46.6 | 9.1 | * | * | ** |
| propoxy)diphonylketona | 59-8 | | | | | | | | |
| N-(2-aminoethyl)3-aminopropyl- | 1760- | Tetraethoxysilane | 4.0 | * | * | ** | * | * | * * |
| trimethoxysilane | 24-3 | | | | | | | | |

*: 5° or lower
**: Incalculatable

### Example 2

Decyltriethoxysilane, tetramethoxysilane (tetramethoxysilane/decyltriethoxysilane=4 (molar ratio)), ethanol and hydrochloric acid were mixed together, and the mixture was then stirred at room temperature for a given time. The obtained solution was spin coated onto the surfaces of various substrates shown in Table 2, and then allowed to stand at room temperature for one day.

The values of advancing (θA) and receding (θR) contact angles and hysteresis of various samples relative to Milli-Q water and n-hexadecane in Example 2 are tabulated in Table 2. As shown in Table 2, it has been confirmed that surfaces having a small hysteresis are formed irrespective of substrate. In particular, the effects on copper, brass, silicon, polycarbonate, glass, and silicone resin having a flat surface were found to be notable.

TABLE 2

| | Milli-Q Water | | | n-hexadecane | | |
|---|---|---|---|---|---|---|
| | Advancing | Receding | | | Receding | |
| | Contact | Contact | | Advancing | Contact | |
| | Angle | Angle | Hysteresis | Contact | Angle | Hysteresis |
| Substrate | (° ) | (° ) | (° ) | Angle (° ) | (° ) | (° ) |
| Copper | 108.2 | 101.6 | 6.7 | 29.0 | 23.3 | 5.7 |
| Brass | 107.8 | 99.8 | 8.0 | 30.0 | 25.1 | 4.9 |
| Silicon | 104.7 | 98.2 | 6.5 | 32.2 | 30.6 | 1.6 |
| Polycarbonate | 108.3 | 100.3 | 8.0 | 33.6 | 32.6 | 1.0 |
| Glass | 112.0 | 102.8 | 9.2 | 38.8 | 37.6 | 1.2 |
| Silicone Resin | 105.2 | 96.3 | 9.0 | 19.9 | 15.4 | 4.5 |
| Japanese | 115.9 | 81.7 | 34.2 | * | * | ** |
| Cypress | | | | | | |
| Ribbon | 147.1 | 96.6 | 50.5 | * | * | ** |

*: 5° or lower
**: Incalculatable

### Example 3

Decyltriethoxysilane, tetramethoxysilane (tetramethoxysilane/decyltriethoxysilane=4 (molar ratio)), ethanol and hydrochloric acid were mixed together, and the mixture was then stirred at room temperature for a given time. The obtained solution was dip coated onto a glass tube, and then allowed to stand at room temperature for one day.

FIG. 2 (left glass tube) shows a state of the inner wall of the glass tube after n-hexadecane (0.5 ml) stained by Sudan III was added dropwise to it in Example 3. As shown in FIG. 2, it has been confirmed that a surface having a small hysteresis can be formed uniformly even onto such a curved surface as found within a pipe by selection of the optimum coating process.

### Example 4

Decyltriethoxysilane, tetramethoxysilane (tetramethoxysilane/decyltriethoxysilane=4 (molar ratio)), ethanol and hydrochloric acid were mixed together, and the mixture was then stirred at room temperature for a given time. The obtained solution was spin coated onto a glass substrate, and then allowed to stand at room temperature for one day.

The values of the advancing (θA) and receding (θR) contact angles and hysteresis of various samples relative to liquids having different surface tensions in Example 4 are tabulated in Table 3. As shown in Table 3, it has been confirmed that surfaces having a small hysteresis are formed irrespective of liquid's surface tension.

TABLE 3

| Liquid Droplets | | | Receding | |
|---|---|---|---|---|
| | Surface | Advancing | Contact | |
| | Tension | Contact | Angle | Hysteresis |
| Name of the Liquid | (dynes/cm) | Angle (°) | (°) | (°) |
| Milli-Q Water | 72.8 | 112.0 | 102.8 | 9.2 |
| Bis(hydroxyethyl)- | 66.4 | 82.8 | 74.3 | 8.5 |
| dimethylammonium | | | | |
| methanesulfonate | | | | |
| Iodomethane | 50.8 | 72.8 | 71.1 | 1.7 |
| Ethylene Glycol | 48.4 | 84.6 | 74.6 | 10.0 |
| Oleic Acid | 32.8 | 52.3 | 47.4 | 4.9 |
| Toluene | 28.4 | 37.5 | 36.1 | 1.4 |
| p-Xylene | 28.3 | 38.6 | 37.4 | 1.2 |
| n-Hexadecane | 27.5 | 38.8 | 37.6 | 1.2 |
| Terpene Oil | 27 | 31.2 | 30.8 | 0.4 |
| n-dodecane | 25.4 | 27.1 | 24.7 | 2.4 |
| n-decane | 23.8 | 21.1 | 20.2 | 0.9 |
| Ethanol | 22.4 | 29.5 | 25.4 | 4.1 |
| 2-Propanol | 20.7 | 15.2 | 7.2 | 8.0 |

*: 5° or lower
**: Incalculatable

### Example 5

Decyltriethoxysilane, tetramethoxysilane (tetramethoxysilane/decyltriethoxysilane=4 (molar ratio)), ethanol and hydrochloric acid were mixed together, and the mixture was then stirred at room temperature for a given time. The obtained solution was spin coated onto a glass substrate, and then allowed to stand at room temperature for one day.

The values of the advancing (θA) and receding (θR) contact angles and hysteresis of various samples relative to a mixed liquid comprising a mixture of two or more liquids in Example 5 are tabulated in Table 4. As shown in Table 4, it has been confirmed that surfaces having a small hysteresis are formed even on the mixed liquid comprising a mixture of two or more liquids.

TABLE 4

| | Advancing | Receding | |
|---|---|---|---|
| Liquid Droplets | Contact | Contact | Hysteresis |
| Name of the Liquid | Angle (°) | Angle (°) | (°) |
| Soybean Oil | 52.1 | 47.1 | 5.0 |
| Kerosene | 29.0 | 27.0 | 2.1 |
| Horse Oil | 52.3 | 47.0 | 5.3 |
| Aqueous Solution of Ethylene Glycol | 101.9 | 96.6 | 5.3 |
| (50 wt %) | | | |
| Aqueous Solution of Ethylene Glycol | 89.0 | 83.1 | 5.9 |
| (75 wt %) | | | |

### Example 6

Decyltriethoxysilane, tetramethoxysilane (tetramethoxysilane/decyltriethoxysilane=4 (molar ratio)), ethanol and hydrochloric acid were mixed together, and the mixture was then stirred at room temperature for a given time. The obtained solution was spin coated onto a glass substrate, and then allowed to stand at room temperature for one day.

FIG. 3 (left photograph) shows the appearance of the surface of a sample in Example 6 against which fingerprints were pressed. As shown in FIG. 3, it has been confirmed that fingerprints were less likely to be deposited on the surface of the sample. This has demonstrated that a surface having a small hysteresis is formed even on a mixture such as fingerprints (comprising sebum, sweat, etc.).

### Example 7

N-(2-aminoethyl)3-aminopropyltrimethoxysilane, tetramethoxysilane (tetramethoxysilan/N-(2-aminoethyl)3-aminopropyltrimethoxysilane-4 (molar ratio)), ethanol and hydrochloric acid were mixed together, and the mixture was then stirred at room temperature for a given time. The obtained solution was spin coated onto a glass substrate, and then allowed to stand at room temperature for one day.

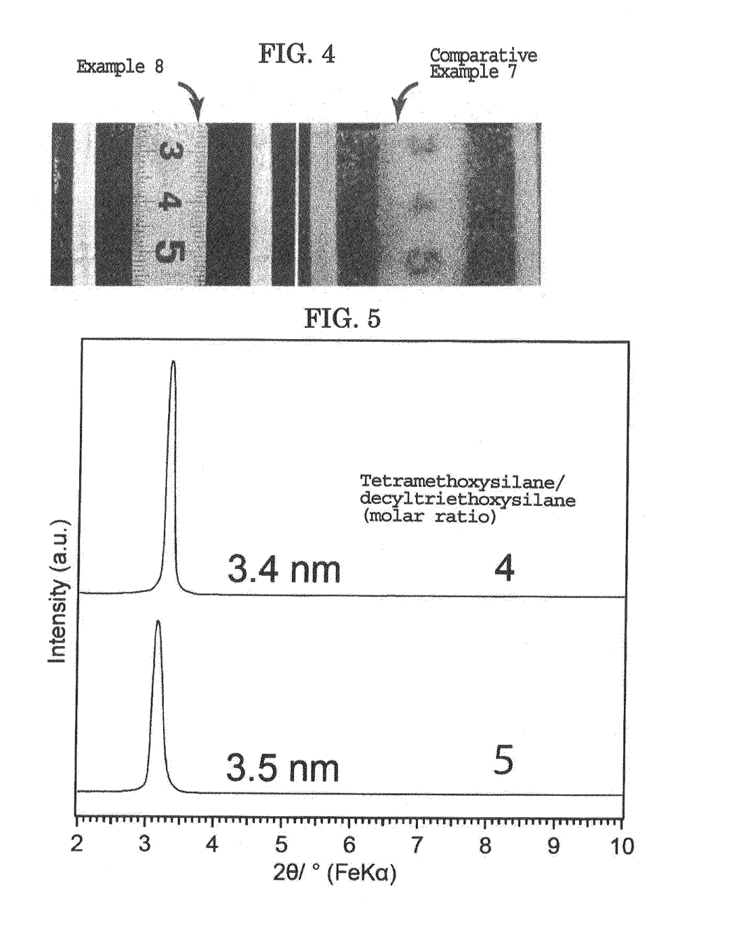

FIG. 4 (left photograph) shows the appearance of a sample after exposed to a vapor (having a relative humidity of 100%) in Example 5. As shown in FIG. 4, it has been confirmed that the numerals on the back side of the film are clearly readable even after exposure to the vapor, indicating that a surface having improved de-misting capability is formed.

### Example 8

Decyltriethoxysilane, ethyltriethoxysilane and tetramethoxysilane or decyltrimethoxysilane, aminopropyltrimethoxysilane and tetramethoxysilane were mixed together at given ratios (Table 5), and the mixture was blended with ethanol and hydrochloric acid, followed by to stirring at room temperature for a given time. The obtained solution was spin coated onto a glass substrate, and then allowed to stand at room temperature for one day.

The values of the advancing (θA) and receding (θR) contact angles and hysteresis of various samples relative to Milli-Q water and n-hexadecane in Example 8 are tabulated in Table 5. As shown in Table 5, it has been confirmed that even when two organosilanes are mixed together, there is a surface having a small hysteresis formed.

TABLE 5

| | | | | | Milli-Q water | | |
|---|---|---|---|---|---|---|---|
| | | | Metal | Metal | Advancing | Receding | |
| Organosilane 1 | Organosilane 2 | Organosilane 1/ | alkoxide | alkoxide/ | Contact | Contact | |
| Name of the | Name of the | Organosilane 2 | Name of the | Organosilane 1 | Angle | Angle | Hysteresis |
| Compound | Compound | Molar ratio | Compound | Molar ratio | (° ) | (° ) | (° ) |
| Decyltrietho- | Ethyltrietho- | 4.0 | Tetrametho- | 4.0 | 107.1 | 102.8 | 4.3 |
| xysilane | xysilane | 10.0 | xysilane | | 107.0 | 103.8 | 3.3 |
| Decyltrietho- | 3-Aminopro- | 0.6 | Tetrametho- | 3.1 | 110.6 | 106.9 | 3.7 |
| xysilane | pyltriethoxysilane | 1.3 | xysilane | 4.4 | 110.1 | 104.4 | 5.7 |
| | | 13.0 | | 7.4 | 111.3 | 108.5 | 2.9 |
| n-hexadecane | | | | | | | |
| Advancing | Receding | | | | | | |
| Contact | Contact | Hysteresis | | | | | |
| Angle (° ) | Angle (° ) | (° ) | | | | | |
| 31.8 | 28.7 | 3.1 | | | | | |
| 31.3 | 27.3 | 4.0 | | | | | |
| 35.4 | 33.2 | 2.3 | | | | | |
| 37.4 | 34.5 | 2.9 | | | | | |
| 40.1 | 36.2 | 4.0 | | | | | |

### Example 9

Decyltriethoxysilane and two metal alkoxides were mixed together at given ratios (Table 6), and blended with ethanol and hydrochloric acid. Then, the blend was stirred at room temperature for a given time. The obtained solution was spin coated onto a glass substrate, and allowed to stand at room temperature for one day.

The values of the advancing (θA) and receding (θR) contact angles and hysteresis of various samples relative to Milli-Q water and n-hexadecane in Example 9 are tabulated in Table 6. As shown in Table 6, it has been confirmed that even when two metal alkoxides are mixed together, there is a surface having a small hysteresis formed.

TABLE 6

| | | Metal | Metal | Milli-Q Water | | |
|---|---|---|---|---|---|---|
| | Metal | Alkoxide 2 | alkoxide 2/ | Advancing | Receding | |
| Organosilane | Alkoxide 1 | Name of the | Metal | Contact | Contact | |
| Name of the | Name of the | Compound | alkoxide 1 | Angle | Angle | Hysterosis |
| Compound | Compound | (CAS) | Molar Ratio | (° ) | (° ) | (° ) |
| Decyltriethoxy- | Tetramethoxysilane | Titanium | 0.05 | 103.6 | 87.5 | 16.2 |
| silane | | Tetraisopropoxide | 0.1 | 104.1 | 83.2 | 20.9 |
| | | (546-68-9) | 0.2 | 104.1 | 84.3 | 19.9 |
| | | | 0.4 | 105.7 | 87.0 | 18.7 |
| | | Zirconium (IV) | 0.05 | 103.3 | 85.0 | 18.3 |
| | | Tetraisopropoxide | 0.1 | 102.4 | 86.0 | 16.4 |
| | | (2171-98-4) | 0.2 | 102.4 | 81.8 | 20.6 |
| | | | 0.4 | 104.1 | 85.0 | 19.1 |
| n-hexadecane | | | | | | |
| Advancing | Receding | | | | | |
| Contact | Contact | | | | | |
| Angle | Angle | Hysteresis | | | | |
| (° ) | (° ) | (° ) | | | | |
| 30.5 | 28.0 | 2.5 | | | | |
| 29.0 | 24.7 | 4.3 | | | | |
| 23.8 | 22.2 | 1.5 | | | | |
| 18.1 | 15.1 | 3.1 | | | | |
| 23.7 | 18.1 | 5.6 | | | | |
| 14.4 | 9.4 | 5.0 | | | | |
| 11.1 | 4.0 | 7.2 | | | | |
| 4.4 | 3.5 | 0.9 | | | | |

### Example 10

Decyltriethoxysilane and tetramethoxysilane were mixed together at given ratios (Table 7), and blended with ethanol and hydrochloric acid. Then, the blend was stirred at room temperature for a given time. The obtained solution was spin coated onto a glass substrate, and then allowed to stand at room temperature for one day.

The film thicknesses of various samples in Example 10 are tabulated in Table 7. As shown in Table 7, it has been confirmed that the film thickness can be controlled as desired by the molar ratios between the organosilane and the metal alkoxide.

TABLE 7

| | | Metal | |
|---|---|---|---|
| Organosilane | Metal Alkoxide | Alkoxide/ | Film |
| Name of the | Name of the | Organosilane | Thickness |
| Compound | Compound | (molar ratio) | (nm) |
| Decyltriethoxysilane | Tetramethoxysilane | 2.00 | 633.0 |
| | | 3.00 | 680.0 |
| | | 4.00 | 800.0 |
| | | 5.00 | 846.0 |
| | | 6.00 | 912.0 |
| | | 7.00 | 973.0 |
| | | 8.00 | 1038.0 |
| | | 9.00 | 1020.0 |
| | | 10.00 | 1217.0 |

### Example 11

Decyltriethoxysilane, tetramethoxysilane (tetramethoxysilane/decyltriethoxysilane=4 (molar ratio)), ethanol and hydrochloric acid were mixed together, and the mixture was then stirred at room temperature for a given time. After the obtained precursor solution was allowed to stand at room temperature for a given time (1 day to 180 days), it was spin coated onto a glass substrate, and then allowed to stand at room temperature for one day.

The values of the advancing (θA) and receding (θR) contact angles and hysteresis of various samples relative to Milli-Q water and n-hexadecane in Example 11 are tabulated in Table 8. As shown in Table 8, it has been confirmed that even when the precursor solution was stored for 180 days or longer, there is a surface having a small hysteresis formed.

TABLE 8

| | Milli-Q Water | | | n-hexadecane | | |
|---|---|---|---|---|---|---|
| | Advancing | Receding | | Advancing | Receding | |
| Time | Contact | Contact | | Contact | Contact | |
| (Days) | Angle (° ) | Angle (° ) | Hysteresis (° ) | Angle (° ) | Angle (° ) | Hysteresis (° ) |
| 1 | 112.0 | 102.8 | 9.2 | 38.8 | 37.6 | 1.2 |
| 10 | 105.8 | 96.5 | 9.3 | 29.6 | 27.0 | 2.6 |
| 20 | 105.7 | 96.4 | 9.2 | 28.6 | 25.5 | 3.0 |
| 180 | 111.0 | 101.2 | 9.8 | 28.6 | 23.3 | 5.3 |

### Example 12

Decyltriethoxysilane, tetramethoxysilane (tetramethoxysilane/decyltriethoxysilane=4, 5 (molar ratio)), ethanol and hydrochloric acid were mixed together, and the mixture was then stirred at room temperature for a given time. The obtained solution was spin coated onto a glass substrate, and then allowed to stand at room temperature for one day.

The XRD patterns of various samples in Example 12 are presented in FIG. 5. As shown in FIG. 5, the formation of a layer compound having a periodic structure of about 3 nm has been confirmed.

### Example 13

Decyltriethoxysilane, tetramethoxysilane (tetramethoxysilane/decyltriethoxysilane-4 (molar ratio)), ethanol and hydrochloric acid were mixed together, and the mixture was then stirred at room temperature for a given time. The obtained solution was spin coated onto a glass substrate, and then allowed to stand at room temperature for one day.

After the treatment, the surface of the substrate was exposed to vacuum ultraviolet light (VUV) of 172 nm in wavelength at 1,000 Pa for 10 seconds. A portion of the surface damaged by VUV irradiation was removed by a scotch tape. The advancing (θA) and receding (θR) contact angles and hysteresis of the sample relative to Milli-Q water and n-hexadecane before and after the VUV irradiation and after surface removal were found to have such values as set out in Table 9.

As shown in Table 9, it has been confirmed that even when damage to the surface gave rise to a large hysteresis, removal of the damaged site causes a new surface to reappear with the result that the dynamic dewettability of the surface is restored (regeneration of a surface having a small hysteresis).

TABLE 9

| | Milli-Q Water | | | n-hexadecane | | |
|---|---|---|---|---|---|---|
| | Advancing | Receding | | Advancing | Receding | |
| | Contact | Contact | | Contact | Contact | |
| | Angle | Angle | | Angle | Angle | |
| | (° ) | (° ) | Hysteresis (° ) | (° ) | (° ) | Hysteresis (° ) |
| Before VUV | 112.0 | 102.8 | 9.2 | 38.8 | 37.6 | 1.2 |
| Irradiation | | | | | | |
| After VUV | * | * | ** | * | * | ** |
| Irradiation | | | | | | |
| After Surface | 110.0 | 99.8 | 10.2 | 30.7 | 22.8 | 7.9 |
| Removal | | | | | | |

*: 5° or lower
**: Incalculatable

### Example 14

Zirconium tetrapropoxide (about 70% 1-propanol solution hereinafter referred to as ZTP for short) and carboxylic acids (CH₃(CH₂)ₙCOOH, where n=6, 8, 10, 12, 14, 16, 20, 22, were mixed together, and the mixture was stirred at 70° C. in a nitrogen atmosphere for a given time, just after which the solution (referred hereinafter to as ZrCAₓ where x=8, 10, 12, 14, 16, 18, 22, 24) was transferred in a Teflon™ vessel, which was in turn allowed to stand in a 150° C. oven for 12 hours in a closed state.

That vessel was allowed to stand at 80° C. for an additional 12 hours with the lid held open for full removal of the remaining IPA. Glacial acetic acid was added to this solution, which was stirred at 60° C. for 5 minutes. Finally, IPA was added to the solution at a proportion of 1:14 (ZrCAₓ:IPA) to obtain the end solution. The thus obtained solution was spin coated onto a substrate washed by exposure to vacuum ultraviolet light of 172 nm in wavelength at 1,000 Pa for 30 minutes, dried at 60° C. for 10 minutes, and heat treated at 100° C. for 1 hour.

The values of the advancing (θA) and receding (θR) contact angles and hysteresis of various samples relative to n-hexadecane, n-dodecane and n-decane in Example 14 are tabulated in Table 10, and the XRD pattern of the sample where x=18 in Example 14 is presented in Table 6.

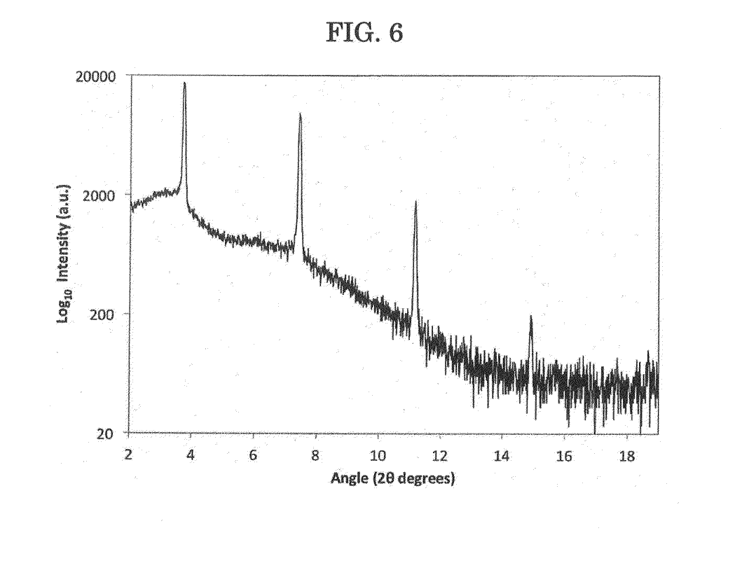

As shown in Table 10 and FIG. 6, it has been confirmed that even when the organic carboxylic acid(s) is used in place of the organosilane, there is a surface having a small hysteresis formed, and that there is a layer structure formed with an interlayer distance of about 3 nm.

TABLE 10

| | n-hexadecane | | | n-dodecane | | | n-decane | | |
|---|---|---|---|---|---|---|---|---|---|
| | Advancing | Receding | | Advancing | Receding | | Advancing | Receding | |
| Name | Contact | Contact | | Contact | Contact | | Contact | Contact | |
| of the | Angle | Angle | Hysteresis | Angie | Angle | Hysteresis | Angle | Angle | Hysteresis |
| Sample | (° ) | (° ) | (° ) | (° ) | (° ) | (° ) | (° ) | (° ) | (° ) |
| ZrCA₈ | 26.9 | 18.9 | 8.0 | 14.5 | 3.8 | 10.7 | 8.9 | 2.6 | 6.3 |
| ZrCA₁₀ | 24.5 | 16.7 | 7.8 | 14.8 | 8.6 | 6.3 | 10.5 | 6.5 | 4.0 |
| ZrCA₁₂ | 22.7 | 17.3 | 5.4 | 14.8 | 11.4 | 3.4 | 8.3 | 5.5 | 2.9 |
| ZrCA₁₄ | 20.7 | 15.5 | 5.2 | 13.8 | 9.6 | 4.3 | 7.5 | 5.4 | 2.1 |
| ZrCA₁₆ | 21.9 | 16.0 | 5.9 | 14.3 | 9.9 | 4.5 | 8.8 | 5.0 | 3.9 |
| ZrCA₁₈ | 25.7 | 16.4 | 9.3 | 14.8 | 8.2 | 6.6 | 10.4 | 5.8 | 4.6 |

### Comparative Example 1

After various glass substrates were cleaned by exposure to vacuum ultraviolet light of 172 nm in wavelength at 1,000 Pa for 30 minutes, organosilane vapors shown in Table 11 were chemically adsorbed from a vapor phase onto the glass substrates. The treatment temperature was 80° C. and the treatment time was 72 hours. The values of dynamic contact angles of various samples relative to Milli-Q water and n-hexadecane in Comparative Example 1 are tabulated in Table 11, and the post-treatment advancing (θA) and receding (θR) contact angles and hysteresis of the surfaces of the substrates were found to have such values as set out in Table 11.

As shown in Table 11, it has been confirmed that when the surfaces of the substrates are treated by the organosilane alone, all the surfaces formed have a large hysteresis.

TABLE 11

| | | | | Milli-Q water | | |
|---|---|---|---|---|---|---|
| | | Metal | Metal | Advancing | Receding | |
| | | alkoxide | alkoxide/ | Contact | Contact | |
| Organosilanes | | Name of the | Organosilane | Angle | Angle | Hysteresis |
| Name of the Compounds | CAS | Compounds | Molar ratio | (° ) | (° ) | (° ) |
| Octadecyltriethoxysilane | 7399-00-0 | — | — | 127.4 | 88.4 | 39.0 |
| Hexadecyltriethoxysilane | 16415-13-7 | — | — | 71.2 | 45.4 | 25.8 |
| Tetradecyltriethoxysilane | 16153-27-8 | — | — | 88.6 | 62.9 | 25.7 |
| Dodecyltriethoxysilane | 18536-91-9 | — | — | 107.0 | 97.9 | 9.1 |
| Decyltriethoxysilane | 2943-73-0 | — | — | 109.0 | 86.0 | 23.0 |
| Octyltriethoxysilane | 2943-75-1 | — | — | 103.5 | 94.0 | 9.4 |
| Hexyltriethoxysilane | 18166-37-5 | — | — | 113.6 | 85.0 | 28.6 |
| Propyltriethoxysilane | 2550-02-9 | — | — | 91.0 | 74.5 | 16.4 |
| Ethyltriethoxysilane | 78-07-9 | — | — | 94.3 | 74.9 | 19.4 |
| Methyltriethoxysilane | 2031-67-6 | — | — | 96.9 | 78.2 | 18.7 |
| 3,3,3-trifluoropropyltrimethoxysilane | 429-60-7 | — | — | 91.0 | 73.0 | 18.0 |
| Nonafiuorohexyltriethoxysilane | 102390-98-7 | — | — | 112.0 | 85.1 | 26.9 |
| Tridecafluorooctyltriethoxysilane | 51851-37-7 | — | — | 104.5 | 81.1 | 23.4 |
| Heptadecafluorooctyltriethoxysilane | 101947-16-4 | — | — | 121.0 | 105.0 | 16.0 |
| Vinyltriethoxysilane | 78-08-0 | — | — | 96.1 | 80.1 | 16.0 |
| 2-hydroxy-4-(3- | 79876-59-8 | — | — | 92.0 | 77.6 | 14.3 |
| triethoxysilylpropoxy)diphenylketone | | | | | | |
| N-(2-aminoethyl)3- | 1760-24-3 | — | — | * | * | ** |
| aminopropyltriethoxysilane | | | | | | |
| n-hexadecane | | | | | | |
| Advancing | Receding | | | | | |
| Contact | Contact | Hysteresis | | | | |
| Angle (° ) | Angle (° ) | (° ) | | | | |
| 30.6 | 8.2 | 22.4 | | | | |
| 17.7 | 6.7 | 11.1 | | | | |
| 31.3 | 20.6 | 10.7 | | | | |
| 26.0 | 19.0 | 7.0 | | | | |
| 21.0 | 8.0 | 13.0 | | | | |
| 33.3 | 19.9 | 13.4 | | | | |
| 46.3 | 22.2 | 24.1 | | | | |
| 21.8 | 12.7 | 9.0 | | | | |
| 26.9 | 18.3 | 8.5 | | | | |
| 28.6 | 6.8 | 21.7 | | | | |
| 39.0 | 23.0 | 16.0 | | | | |
| 63.0 | 56.0 | 7.0 | | | | |
| 70.3 | 54.4 | 15.9 | | | | |
| 63.0 | 51.4 | 11.6 | | | | |
| 28.5 | 20.5 | 7.9 | | | | |
| 33.0 | 21.5 | 11.5 | | | | |
| * | * | ** | | | | |

*: 5° or lower
**: Incalculatable

### Comparative Example 2

After various substrates were exposed to vacuum ultraviolet light of 172 nm in wavelength at 1,000 Pa for a given time, decyltriethoxysilane vapors were chemically adsorbed from a vapor phase onto the substrates. The treatment temperature was 80° C. and the treatment time was 72 hours. The values of dynamic contact angles of various samples relative to Milli-Q water and n-hexadecane in Comparative Example 2 are tabulated in Table 12, and the post-treatment advancing (θA) and receding (θR) contact angles and hysteresis of the surfaces of the substrates were found to have such values as set out in Table 12.

As shown in Table 12, when the surfaces of the substrates are treated by the organosilane alone, surfaces having a small roughness like glass or silicone surfaces have a small hysteresis, but that hysteresis is still larger as compared with the organic/inorganic hybrid films. The surfaces of other substrates have a large hysteresis, indicating that there are surfaces having poor dynamic dewettability formed.

TABLE 12

| | Milli-Q Water | | | n-hexadecane | | |
|---|---|---|---|---|---|---|
| | | Receding | | | Receding | |
| | Advancing | Contact | | Advancing | Contact | |
| | Contact | Angle | Hysteresis | Contact | Analge | Hysteresis |
| Substrate | Angle (° ) | (° ) | (° ) | Angle (° ) | (° ) | (° ) |
| Copper | 118.1 | 80.7 | 37.4 | 6.7 | * | >6.7 |
| Brass | 107.8 | 87.5 | 20.4 | 35.3 | 18.7 | 16.6 |
| Silicon | 103.1 | 93.7 | 9.4 | 12.9 | 3.7 | 9.2 |
| Polycarbonate | 96.7 | 76.1 | 20.7 | 8.1 | * | >8.1 |
| Glass | 109.0 | 86.0 | 23.0 | 21.0 | 8.0 | 13.0 |
| Silicone Resin | 117.2 | 83.9 | 33.3 | 52.2 | 10.8 | 41.4 |
| Japanese | 138.5 | 39.2 | 99.3 | * | * | ** |
| cypress | | | | | | |
| Ribbon | * | * | ** | * | * | ** |

*: 5° or lower
**: Incalculatable

### Comparative Example 3

After the inner wall of a glass tube was degreased by acetone, decyltriethoxysilane vapor was chemically adsorbed from a vapor phase onto the glass tube. The treatment temperature was 80° C. and the treatment time was 72 hours. Added dropwise into the glass tube was n-hexadecane (0.5 mL) stained by Sudan III. FIG. 2 (left glass tube) shows a state of the inner wall of the glass tube after n-hexadecane (0.5 mL) stained by Sudan III was added dropwise to it in Comparative Example 3.

As shown in FIG. 2, it has been confirmed that when the surface of interest is treated by the organosilane alone, n-hexadecane is wettingly spread over the inner surface of the glass tube, providing a surface having a larger hysteresis as compared with the organic/inorganic hybrid film.

### Comparative Example 4

After various glass substrates were washed by exposure to vacuum ultraviolet light of 172 nm in wavelength at 1,000 Pa for 30 minutes, decyltriethoxysilane vapors were chemically adsorbed from a vapor phase onto the glass substrates. The treatment temperature was 80° C. and the treatment time was 72 hours. The values of dynamic contact angles of various samples relative to various liquids having different surface tensions in Comparative Example 4 are tabulated in Table 13, and the post-treatment advancing (θA) and receding (θR) contact angles and hysteresis of the surfaces of the substrates were found to have such values as set out in Table 13.

As shown in Table 13, when the surface of interest was treated by the organosilane alone, the values of hysteresis relative to the liquids having different surface tensions were larger as compared with the organic/inorganic hybrid film. Especially, it has been found that use of liquid droplets having a surface tension smaller than that of n-decane gives rise to a full wetting spreading of them over the surface.

TABLE 13

| Liquid Droplets | | | Recding | |
|---|---|---|---|---|
| | Surface | Advancing | Contact | |
| | Tension | Contact | Angle | Hysteresis |
| Name of the Liquids | (dyn/cm) | Angle (°) | (°) | (°) |
| Milli-Q water | 72.8 | 109.0 | 86.0 | 23.0 |
| bis(hydroxyethyl)- | 66.4 | 70.7 | * | >70.7 |
| dimethylammonium | | | | |
| methane sulfonate | | | | |
| iodomethan | 50.8 | 68.5 | 59.4 | 9.1 |
| ethylene glycol | 48.4 | 82.7 | 67.8 | 14.9 |
| oleic acid | 32.8 | 41.7 | 26.5 | 15.2 |
| toluene | 28.4 | 22.6 | 13.9 | 8.7 |
| p-xylene | 28.3 | 24.7 | 13.7 | 11.0 |
| n-hexadecane | 27.5 | 21.0 | 8.0 | 13.0 |
| terpene oil | 27.0 | 16.2 | 4.7 | 11.5 |
| n-dodecane | 25.4 | 7.3 | * | >7.3 |
| n-decane | 23.8 | * | * | ** |
| ethanol | 22.4 | * | * | ** |
| 2-propanaol | 20.7 | * | * | ** |

*: 5° or lower
**: Incalculatable

### Comparative Example 5

After various glass substrates were washed by exposure to vacuum ultraviolet light of 172 nm in wavelength at 1,000 Pa for 30 minutes, decyltriethoxysilane vapors were chemically adsorbed from a vapor phase onto the glass substrates. The treatment temperature was 80° C. and the treatment time was 72 hours.

The values of dynamic contact angles of various samples relative to mixed liquids comprising a mixture of two or more liquids in Comparative Example 5 are tabulated in Table 14, and the post-treatment advancing (θA) and receding (θR) contact angles and hysteresis of the surfaces of the substrates relative to mixed liquids comprising a mixture of two or more liquids were found to have such values as set out in Table 14.

As shown in Table 14, when the surface of interest was treated by the organosilane alone, the hysteresis relative to liquids having different surface tensions had a larger value as compared with the organic/inorganic hybrid film.

TABLE 14

| | Advancing | Receding | |
|---|---|---|---|
| Liquid Droplets | Contact | Contact | Hysteresis |
| Name of the Liquids | Angle (°) | Angle (°) | (°) |
| Soy bean oil | 44.6 | 27.3 | 17.3 |
| Kerosene | 3.5 | * | >3.5 |
| Horse oil | 43.1 | 28.4 | 14.7 |
| Aqueous solution of ethylene glycol | 99.4 | 88.2 | 11.3 |
| (50 wt %) | | | |
| Aqueous solution of ethylene glycol | 87.9 | 74.8 | 13.1 |
| (75 wt %) | | | |

*: 5° or lower

### Comparative Example 6

After various glass substrates were washed by exposure to vacuum ultraviolet light of 172 nm in wavelength at 1,000 Pa for 30 minutes, decyltriethoxysilane vapors were chemically adsorbed from a vapor phase onto the glass substrates. The treatment temperature was 80° C. and the treatment time was 72 hours. After the post-treatment glass substrates were let stand, fingers were pressed against their surfaces to observe their anti-fingerprint property were left. FIG. 3 shows the appearance of the surface of the sample after fingerprints were pressed against it in Comparative Example 6.

As shown in FIG. 3, it has been confirmed that when the surface of interest was treated by the organosilane alone, the fingerprints are clearly left thereon, indicating that the surface formed has a larger hysteresis as compared with the organic/inorganic hybrid film.

### Comparative Example 7

After various glass substrates were washed by exposure to vacuum ultraviolet light of 172 nm in wavelength at 1,000 Pa for 30 minutes, N-(2-aminoethyl)3-aminopropyltrimethoxysilane vapors were chemically adsorbed from a vapor phase onto the glass substrates. The post-treatment glass substrates were exposed to a vapor having a relative humidity of 100% to observe changes in transparency of the substrates. FIG. 4 (right photograph) shows the appearance of the sample after exposed to the vapor (having a relative humidity of 100%) in Comparative Example 7.

As shown in FIG. 4, it has been found that when the surface of interest was treated by the organosilane alone, light scattered from liquid droplets condensing on the surface to such an extent that the numerals on the back side were not clearly readable, indicating that there is the absence of any de-misting capability.

### Comparative Example 8

After various glass substrates were washed by exposure to vacuum ultraviolet light of 172 nm in wavelength at 1,000 Pa for 30 minutes, mixed vapors of decyltriethoxysilane and ethyltriethoxysilane were chemically adsorbed from a vapor phase onto the glass substrates. The treatment temperature was 80° C. and the treatment time was 72 hours. The values of dynamic contact angles of various samples in Comparative Example 8 are tabulated in Table 15. The advancing (θA) and receding (θR) contact angles and hysteresis of the surfaces of the post-treatment samples relative to Milli-Q water and n-hexadecane were found to have such values as set out in table 15.

As shown in Table 15, when the surface of interest was treated by the organosilane alone, the surface treated had a larger hysteresis as compared with the organic/inorganic hybrid film.

TABLE 15

| | | | | | Milli-Q water | | |
|---|---|---|---|---|---|---|---|
| | | | Metal | Metal | Advancing | Receding | |
| Organosilane 1 | Organosilane 2 | Organosilane 1/ | alkoxide | alkoxide/ | Contact | Contact | |
| Name of the | Name of the | Organosilane 2 | Name of the | Organosilane 1 | Angle | Angle | Hysteresis |
| Compoounds | Compounds | Molar ratio | Compound | Molar ratio | (° ) | (° ) | (° ) |
| Decyltriethoxy- | Ethyltriethoxy- | 4.0 | — | — | 100.2 | 76.0 | 24.2 |
| silane | silane | | | | | | |
| Deoyltriethoxy- | 3-Aminopropyl- | 0.6 | — | — | 101.8 | 78.8 | 23.0 |
| silane | triethoxysilane | 1.3 | | — | 106.1 | 84.6 | 21.6 |
| | | 13.0 | | — | 111.6 | 95.8 | 15.8 |
| n-hexadecane | | | | | | | |
| Advancing | Receding | | | | | | |
| Contact | Contact | Hysteresis | | | | | |
| Angle (° ) | Angle (° ) | (° ) | | | | | |
| 7.6 | * | >7.6 | | | | | |
| 29.3 | 21.2 | 8.0 | | | | | |
| 17.4 | 12.2 | 5.2 | | | | | |
| 49.2 | 41.4 | 7.8 | | | | | |

*: 5° or lower

### Comparative Example 9

After various glass substrates were washed by exposure to vacuum ultraviolet light of 172 nm in wavelength at 1,000 Pa for 30 minutes, decyltriethoxysilane vapors were chemically adsorbed from a vapor phase onto the glass substrates. The treatment temperature was 80° C. and the treatment time was 72 hours.

The surface of the post-treatment substrate was exposed to VUV of 172 nm in wavelength at 1,000 Pa for 10 seconds, after which a scotch tape was used to remove off a portion of the surface damaged by VUV irradiation. The advancing (θA) and receding (θR) contact angles and hysteresis of the substrate relative to Milli-Q water and n-hexadecane before and after VUV irradiation and before surface removal were found to have such values as set out in Table 16.

As shown in Table 16, it has been clear that once the surface treated by the organosilane alone is damaged incurring degradation of dynamic dewettability, that property cannot be restored back.

TABLE 16

| | Milli-Q Water | | | n-hexadecane | | |
|---|---|---|---|---|---|---|
| | Advancing | Receding | | Advancing | Receding | |
| | Contact | Contact | | Contact | Contact | |
| | Angle (° ) | Angle (° ) | Hysteresis (° ) | Angle (° ) | Angle (° ) | Hysteresis (° ) |
| Before VUV | 109.0 | 86.0 | 23.0 | 21.0 | 8.0 | 13.0 |
| Irradiation | | | | | | |
| After VUV | * | * | ** | * | * | ** |
| Irradiation | | | | | | |
| After Surface | * | * | ** | * | * | ** |
| Removal | | | | | | |

*: 5° or lower
**: Incalculatable

### Comparative Example 10

ZTP and IPA were blended with each other at a proportion of 1:14 (ZTP:IPA) to obtain a solution. The obtained solution was spin coated onto a glass substrate washed by exposure to vacuum ultraviolet light of 172 nm in wavelength at 1,000 Pa for 30 minutes, then dried at 60° C.□ for 10 minutes, and then heated at 100° C. for 1 hour. The solvents: n-hexadecane, n-dodecane and n-decane were all wettingly spread over the obtained surface.

The surfaces of the substrate samples prepared in Examples 1-14 and Comparative Examples 1-10 were relatively estimated. From the results of Examples 1-10 and 12-14 and Comparative Examples 1-10, it has been found that the addition of the metal alkoxide to the organosilane ensures that the hysteresis is smaller as compared with the surface treated by the organosilane alone, resulting in the achievement of a surface having improved water repellency/oil repellency, resistance to fingerprint adhesion and de-misting capability. From Example 11 it has been found that the more the concentration of tetramethoxysilane that provides a solid component after film formation, the greater the film thickness becomes. It follows that the film thickness is controllable depending on the concentration of the solid component. It has further been found that as shown in Example 12, there may be a layer structure formed under certain specific conditions.

Commonly, it has be considered that the addition of the metal alkoxide that is an inorganic component would incur poor dynamic dewettability due to an increase in the hydroxyl groups (—OH) exposed on a solid surface. However, the obtained results indicate the opposite: improvements in dynamic dewettability. This has revealed that the addition of the inorganic component makes the inter-organic site distance derived from the organosilane longer with the result that the mobility of the organic sites increases considerably, leading to improvements in the ability to remove liquid droplets.

As shown in Example 1 in particular, even the addition of the metal alkoxide to the organosilane in an amount of 100 folds (molar ratio) resulted in the formation of a surface having a small hysteresis. As shown further in Examples 10 and 14, even when different metal alkoxide types were mixed together or an organic carboxylic acid(s) was used in place of the organosilane for film preparation, there was again a film having a small hysteresis obtained. Thus, the results of Examples 1-10 and 14 indicate that this mechanism is not limited to a specific organosilane/metal alkoxide proportion; so it may be applied not only to every organosilane molecule but to organic carboxylic acids and organic phosphonic acids as well.

It has generally been known that surface treatment by the organosilane alone has difficulty in application to surfaces having a large roughness or substrate surfaces having a low reactivity. Indeed, it has also been found from the results of Comparative Example 2 that substrates having a small roughness like glass or silicon may be treated to a certain degree although there is a somewhat large hysteresis occurring. However, other substrates have a noticeably large hysteresis or liquid droplets are wettingly spread over them.

From a comparison of Example 2 with Comparative Example 2, it has been appreciated that the treatment described herein may render it possible to obtain surfaces having a small hysteresis irrespective of their substrate. As can also be seen from Examples 4 and 11 in particular, it has been appreciated that the treatment technology described herein is very versatile because the precursor solution can be stored over an extended period of time without recourse to any special treatment processes and conditions.

### INDUSTRIAL APPLICABILITY

As described in greater details, the invention relates to an organic/inorganic transparent hybrid film and a method for producing the same. According to the invention, it is possible to provide an organic/inorganic transparent film obtained by coating a precursor solution obtained by co-hydrolysis and polycondensation of an organosilane and a metal alkoxide in a solution containing an organic solvent, water and a catalyst onto a surface of a substrate such as a metal, a metal oxide film, an alloy, a semiconductor, a polymer, a ceramics, a glass, a resin, a wood, a paper and a fiber, in which a transparent film of good adhesion is formed simultaneously with volatilization of the solvent, and by control of mobility of functional groups derived from the organosilane on the film surface, improved water repellency/oil repellency, ability of liquid droplets to roll off, liquid droplet removal capability, anti-fingerprint properties and defogging properties can be imparted to the surface of the substrate while the properties of the substrate are kept intact, and a method for producing the same.

The present invention provides a new technique and a new product relating to a very useful, novel surface modification technology for industrial applications where it is typically desired to reduce or minimize the interactions between liquid droplets and a solid surface, thereby to improve the ability of automotive glass and construction material glass to remove raindrops and to defog and keep them clean for the field of vision and prevention of sticking of dirt, stain or the like, control water flows through μ-TAS, biochips or the like, control micro-water drops through nozzles, etc. for water-soluble ink jets, prevent corrosion of metals and wood-based materials, improve the releasability of materials out of nanoimprinting molds, impart anti-fingerprint properties to touch panel displays, and so on.

1-24. (canceled)

25. An organic/inorganic transparent hybrid film formed on a solid surface, characterized in that:
said film is a film obtained by co-hydrolysis and polycondensation of an organosilane and a metal alkoxide mixed together at a molar ratio of 1:4 to 100 in a solution containing an organic solvent, water and a catalyst,
said organosilane is an alkyltrimethoxysilane having 8 to 12 carbon atoms or an alkyltriethoxysilane having 8 to 12 carbon atoms,
said metal alkoxide is tetramethoxysilane or tetra-ethoxysilane, and
said film ensures that a contact angle hysteresis (θ_{A}−θ_{B}) of the solid surface upon measurement of a dynamic contact angle, where θ_{A} is an advancing contact angle and θ_{B} is a receding angle, has a value smaller than that of a surface treated by the organosilane alone.

26. An organic/inorganic transparent hybrid film as recited in claim 25, wherein said film ensures that a difference (hysteresis) between the advancing contact angle and the receding contact angle relative to a liquid having a surface tension of 18 to 73 dynes/cm has a value smaller than that of a surface treated by the organo-silane alone.

27. An organic/inorganic transparent hybrid film as recited in claim 25, wherein the obtained organic/inorganic transparent hybrid film has a layer structure with an interlayer distance of 1 to 10 nm.

28. An organic/inorganic transparent hybrid film as recited in claim 25, wherein there is a variable inter-organosilane distance depending on the molar ratio between the organosilane and the metal alkoxide.

29. An organic/inorganic transparent hybrid film as recited in claim 25, wherein said film is less capable of fingerprint adhesion, and fingerprints are easily wiped off even once adhering to it.

30. An organic/inorganic transparent hybrid film as recited in claim 25, wherein said film has aiti-fogging capability.

31. An organic/inorganic transparent hybrid film as recited in claim 25, wherein a mixture of the organosilanes recited in claim 25 with ethyltriethoxysilane or aminopropyltriethoxysilanes is used as an organosilane that provides a raw material of the organic/inorganic transparent film.

32. An organic/inorganic transparent hybrid film as recited in claim 25, wherein a mixture of the metal alkoxide recited in claim 25 with titanium tetraisopropoxide or zirconium tetraisopropoxide is used as a metal alkoxide that providing a raw material of the organic/inorganic transparent hybrid film.

33. A method for producing an organic/inorganic transparent hybrid film, characterized by coating a surface of a substrate with a precursor solution obtained by co-hydrolysis and polycondensation of an alkyltrimethoxysilane having 8 to 12 carbon atoms or an alkyltriethoxysilne having 8 to 12 carbon atoms and tetramethoxysilane or tetraethoxysilane mixed together at a molar ratio of 1:4 to 100 in a solution containing an organic solvent, water and a catalyst, and then evaporating the solvent at room temperature under atmospheric pressure to allow for crosslinkage of the resulting film.

34. A method for producing an organic/inorganic transparent hybrid film as recited in claim 33, which makes use of an organic solvent that is miscible with water used for the hydrolysis, is capable of dissolving a substance obtained after the hydrolysis and polycondensation of the organosilane and metal alkoxide, and has a vapor pressure higher than that of water.

35. A method for producing an organic/inorganic transparent hybrid film as recited in claim 33, wherein the catalyst used for the hydrolysis has an action on acceleration of the hydrolysis of an alkoxy group in the alkyltrimethoxysilane having 8 to 12 carbon atoms or the alkyltriethoxysilne having 8 to 12 carbon atoms or an alkoxy group in the tetramethoxysilane or tetraethoxysilane.

36. A precursor solution used for producing an organic/inorganic transparent hybrid film as recited in claim 25, which is obtained by co-hydrolysis and poly-condensation in a solution containing an organic solvent, water and a catalyst of an alkyltrimethoxysilane having 8 to 12 carbon atoms or an alkyltriethoxysilane having 8 to 12 carbon atoms and tetramethoxysilane or tetraethoxysilane mixed together in a molar ratio of 1:4 to 100.

37. A precursor solution as recited in claim 36, wherein the solvent used is an organic solvent that is miscible with water used for the hydrolysis, is capable of dissolving a substance obtained after the hydrolysis and polycondensation of the organosilane and metal alkoxide, and has a vapor pressure higher than that of water.

38. A precursor solution as recited in claim 36, wherein the catalyst used is a catalyst capable of promoting the hydrolysis of an alkoxy group in the alkyl-trimethoxysilane having 8 to 12 carbon atoms or an alkyl-triethoxysilane having 8 to 12 carbon atoms, and an alkoxy group in tetramethoxysilane or tetraethoxysilane.
